(19) United States
(12) Patent Application Publication
(10) Pub. No.: US 2013/0153481 A1
(43) Pub. Date: Jun. 20, 2013

(54) FILTER SUPPORT MEMBER

(71) Applicant: Michael Joseph Havel, Dallas, TX (US)

(72) Inventor: Michael Joseph Havel, Dallas, TX (US)

(21) Appl. No.: 13/712,709

(22) Filed: Dec. 12, 2012

Related U.S. Application Data
(60) Provisional application No. 61/570,736, filed on Dec. 14, 2011.

(51) Int. Cl. B01D 29/19

(52) U.S. Cl. CPC B01D 29/19
USPC 210/232; 210/457

(57) ABSTRACT

A filter support member includes a plurality of core members and a hinge positioned between at least two of the plurality of core members. The hinge allows pivotal movement of the at least two core members relative to one another about a hinge axis associated with the hinge. The plurality of core members are positionable in an operational position to form a substantially cylindrical body and are further positionable in a stored position to form a substantially flat sheet. The substantially flat sheet occupies a volumetric envelope less than a volumetric envelope of the substantially cylindrical body.

### CROSS REFERENCE TO RELATED APPLICATION

This application claims the benefit of and priority to U.S. Provisional Patent Application No. 61/570,736, filed Dec. 14, 2011, entitled FILTER SUPPORT MEMBER, which is hereby incorporated by reference.

### BACKGROUND

1. Field of the Invention

The invention relates generally to the filtering of fluids and more specifically to a filter support body that is capable of providing support for filter media or other materials that filter the fluids.

2. Description of Related Art

Filters are used in many industrial, commercial and other settings to remove impurities or other particulates from liquids or gases (collectively referred to as fluids). While the actual filtering material is often referred to as filter media or a filter element, the material is typically associated with some type of filter body to support the filter media and in some instances to maintain the proper positioning of the filter media relative to the fluid stream being filtered.

Many times it is desirable for the filter body to maintain a hollow space or inner passage to allow passage of unfiltered fluids prior to passing through the filter media, or alternatively to allow passage of filtered fluids after passing through the filter media. The presence of the hollow space in the filter body increases the difficulty of manufacture, especially when it is desired to use molding techniques. To manufacture such a part, injection molding is typically employed, which requires a secondary side action in the mold, often referred to as a core-pull technique. Such techniques are more expensive and time consuming when compared to other molding techniques.

### SUMMARY

The problems presented in providing filter support elements that are easily manufactured, packaged, shipped, and stored are solved by the systems and methods of the illustrative embodiments described herein. In one embodiment, an apparatus for supporting filter media includes a plurality of core members and a hinge positioned between at least two of the plurality of core members to allow pivotal movement of the at least two core members relative to one another about a hinge axis associated with the hinge. The plurality of core members are positionable in an operational position to form a substantially cylindrical body. The plurality of core member are further positionable in a stored position to form a substantially flat sheet, the substantially flat sheet occupying a volumetric envelope less than a volumetric envelope of the substantially cylindrical body.

In another embodiment, a filter includes a filter support element having a substantially cylindrical body comprised of a plurality of core members. Each of the plurality of core members is pivotally attached to at least another of the plurality of core members. A filter media is positioned around or in contact with the substantially cylindrical body.

In yet another embodiment, an apparatus for supporting filter media is provided. The apparatus includes a plurality of core members, each of the plurality of core members pivotally attached to at least another of the plurality of core members. The plurality of core members are positionable in an operational position to form a filter support body. The plurality of core member are positionable in a stored position to form a sheet, the sheet occupying a volumetric envelope less than a volumetric envelope of the substantially cylindrical body.

Other objects, features, and advantages of the invention will become apparent with reference to the drawings, detailed description, and claims that follow.

### BRIEF DESCRIPTION OF THE DRAWINGS

FIG. 1 illustrates a front isometric view of a filter support member according to an illustrative embodiment, the filter support member arranged in an operational position;

FIG. 2 depicts an enlarged isometric view of a portion of the filter support member of FIG. 1;

FIG. 3 illustrates the filter support member of FIG. 1, the filter support member arranged in a stored position;

FIG. 4 depicts a front view of the filter support member of FIG. 1 in the stored position;

FIG. 5 illustrates a front view of a filter support member according to an illustrative embodiment, the filter support member being illustrated in a stored position;

FIGS. 6A and 6B depict a front view of a filter support member according to an illustrative embodiment, the filter support member in FIG. 6A being illustrated in a stored position and the filter support member in FIG. 6B being illustrated in an operational position;

FIGS. 7A and 7B illustrate a front view of a filter support member according to an illustrative embodiment, the filter support member in FIG. 7A being illustrated in a stored position and the filter support member in FIG. 7B being illustrated in an operational position;

FIGS. 8A and 8B depict a front view of a filter support member according to an illustrative embodiment, the filter support member in FIG. 8A being illustrated in a stored position and the filter support member in FIG. 8B being illustrated in an operational position;

FIGS. 9A and 9B illustrate a front view of a filter support member according to an illustrative embodiment, the filter support member in FIG. 9A being illustrated in a stored position and the filter support member in FIG. 9B being illustrated in an operational position;

FIGS. 10A and 10B depict a front view of a filter support member according to an illustrative embodiment, the filter support member in FIG. 10A being illustrated in a stored position and the filter support member in FIG. 10B being illustrated in an operational position; and

FIG. 11 illustrates a cross-sectional, schematic view of a filter according to an illustrative embodiment, the filter having a filter support member and a filter media.

### DETAILED DESCRIPTION OF THE ILLUSTRATIVE EMBODIMENTS

In the following detailed description of several illustrative embodiments, reference is made to the accompanying drawings that form a part hereof, and in which is shown by way of illustration specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

The filter support members described herein secure and support filter media that is placed around, within, or in contact with the filter support member. Since the filter support member will typically provide a hollow space or inner passage, the filter support member in its operational configuration occupies more volume (i.e. a larger volumetric envelope) than the volume of the material from which the filter support member is formed. The filter support members described herein are capable of being placed in a stored position to eliminate the hollow space or inner passage. The stored position allows the volumetric envelope occupied by the filter support member to be the same as or only a small amount greater than the actual volume of material making up the filter support member. The volumetric envelope associated with the stored position is significantly less than the volumetric envelope occupied by the filter member in an operational position due to the elimination of the inner passage. The substantially flatter, stored position also allows the most cost-effective manufacturing of the filter support member. This flatter profile saves space in inventory and reduces shipping costs.

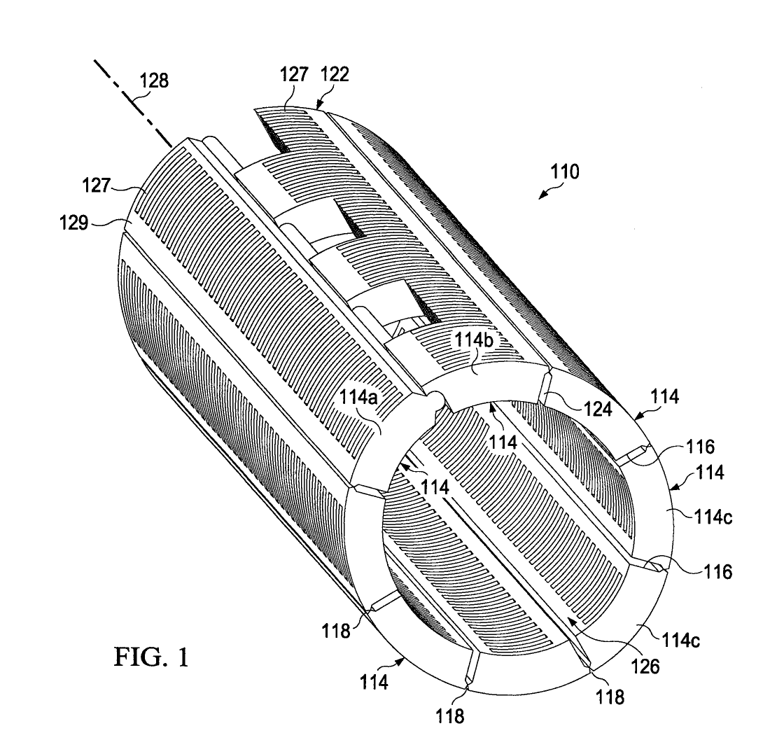

Referring to FIGS. 1-4, a filter support member 110 according to an illustrative embodiment includes a plurality of core members 114, at least two of which are terminal core members 114a, 114b, and the remainder of which are intermediate core members 114c. In one embodiment, each of the intermediate core members 114c is pivotally attached on each of two longitudinal edges 116 to an adjacent core member 114. Each of the terminal core members 114a, 114b may be pivotally attached on one of its longitudinal edges 116 to an adjacent, intermediate core member 114c. In the embodiment illustrated in FIGS. 1-4, the pivotal attachment between adjacent core members 114 is provided by a living hinge 118. The living hinge 118 is preferably integrally attached to each of the associated core members 114 and is the same material as the core members 114. From a manufacturing perspective, the living hinge 118 is molded or machined along with the core members 114 and typically represents a thinner region of material than the two core members 114 that are being joined. The living hinge 118 is configured in both thickness and material to allow repeated rotational movement of the adjacent core members 114. In some embodiments, the living hinge may provide extended durability due to the ability of the living hinge 118 to elastically deform. In other embodiments, the living hinge 118 may experience some plastic deformation, but the living hinge 118 is still able to withstand repeated use without failure.

While the pivotal attachment characteristics have been described as being provided by a living hinge, other hinges may instead be used to provide to the pivotal functionality described above. In one embodiment, mechanical hinges may be associated with the core members 114 to allow rotational movement between adjacent core members 114. These mechanical hinges may take on any particular configuration and may be integrally attached to the core members 114, or may be mechanically, chemically, or thermally attached to each core member 114. In another embodiment, an elastomeric or otherwise flexible film may be bonded or otherwise attached between core members 114 to provide rotational functionality. The flexible film acts much in the same way as a living hinge, allowing pivotal movement based on the flexibility and occasional deformation of the flexible film. Any particular hinge or pivotal attachment means may be employed provided that the hinge or pivotal attachment means is capable of allowing pivotal rotation between two core members about a hinge axis associated with the hinge.

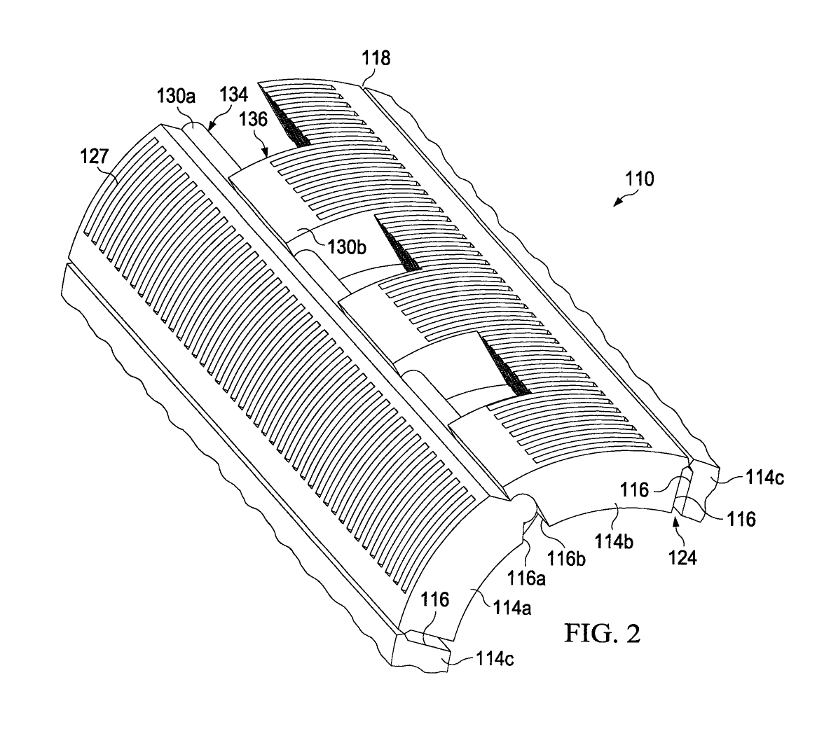

Whether a living hinge or other type of pivotal-attachment device is used, the hinge may be attached along an entire edge of the core member, or alternatively may be placed at one or more locations along the edge. Referring more specifically to FIG. 2, in this embodiment, the living hinge 118 is positioned continuously along the edges 116 of the adjacent core members 114. The living hinge 118, like any hinge or pivotal attachment means that may be employed, includes a hinge axis 120 about which rotation of the two adjacent core members 114 occurs. While illustrated in FIG. 2 as a continuous living hinge, living hinge 118 could instead be discontinuously disposed along the edges 116 of the core members 114. For example, in one embodiment, two separate living hinges may be disposed on the edges 116 at opposite longitudinal ends of the core members 114. Alternatively, multiple but separated living hinges may be provided at various locations along the edges 116. In other embodiments, traditional mechanical hinges may be employed, or other living hinges (such as films, plastics, bonding agents, epoxies) that are bonded or otherwise attached to the core members 114.

Referring again to FIG. 1, the filter support member 110 is positionable in an operational position to form a filter body 122. In the embodiment illustrated in FIG. 1, the filter body 122 is substantially cylindrical in shape with a substantially circular cross-section. Alternatively, the filter body 122 may instead be shaped to have a cross-section that is oval, triangular, square, rectangular, polygonal, semi-circular or half round, or any other shape that is suitable for use with the particular requirements of the filter support member 110.

Beneath each living hinge 118 is a relief region 124 formed between the edges 116 of adjacent core members 114. Each relief region 124 may be shaped and sized to permit pivotable motion between the core members 114, yet limit the range of that pivotable motion when the core members 114 have reached a position that is desired for creating the filter body 122 in the operational position. For example, as the core members 114 are positioned into the operational position, the edges 116 of adjacent core member 114 contact one another, preventing further rotation and helping to ensure that the cylindrical shape of the filter body 122 is formed. The shape and size of the relief region 124 in various embodiments may be different depending on the incline associated with each edge 116.

When positioned in the operational position, the filter body 122 defines an inner passage 126. A longitudinal axis 128 associated with the cylindrical filter body 122 extends axially along the center of the passage 126. The hinge axes 120 about which the core members 114 are capable of rotating are substantially parallel to one another and to the longitudinal axis 128 of the filter body 122. The core members 114 may each include a plurality of apertures 127 to allow fluid communication between an exterior surface 129 of the filter body 122 and the inner passage 126.

Referring to FIG. 2, the filter support member 110 may include complimentary latching members 130a, 130b associated with terminal core members 114a, 114b, respectively. While the shape, size, positioning, and functionality of the latching members may vary in other embodiments, the latching members 130a, 130b are each attached along a terminal edge 116a, 116b of the terminal core members 114a, 114b opposite the edge 116 that is pivotally connected to the adjacent intermediate core member 114c. The latching member 130a is a semi-cylindrical pin 134 integrally attached to the edge 116a of terminal core member 114a. The semi-cylindrical pin 134 is axially aligned parallel to the hinge axes 120. The latching member 130b is a complimentary, semi-cylindrical receiver 136 that is sized and shaped to receive the semi-cylindrical pin 134. In the embodiment illustrated in FIG. 2, the semi-cylindrical receiver subtends an arc of less than 180 degrees, thereby resulting in an attachment means that does not resist unlatching in the presence of opposing forces applied tangentially to the cylindrical filter body 122. Instead the latching members 130a, 130b resist unlatching in the operational position when exposed to radial forces directed inward or outward on the cylindrical filter body 122.

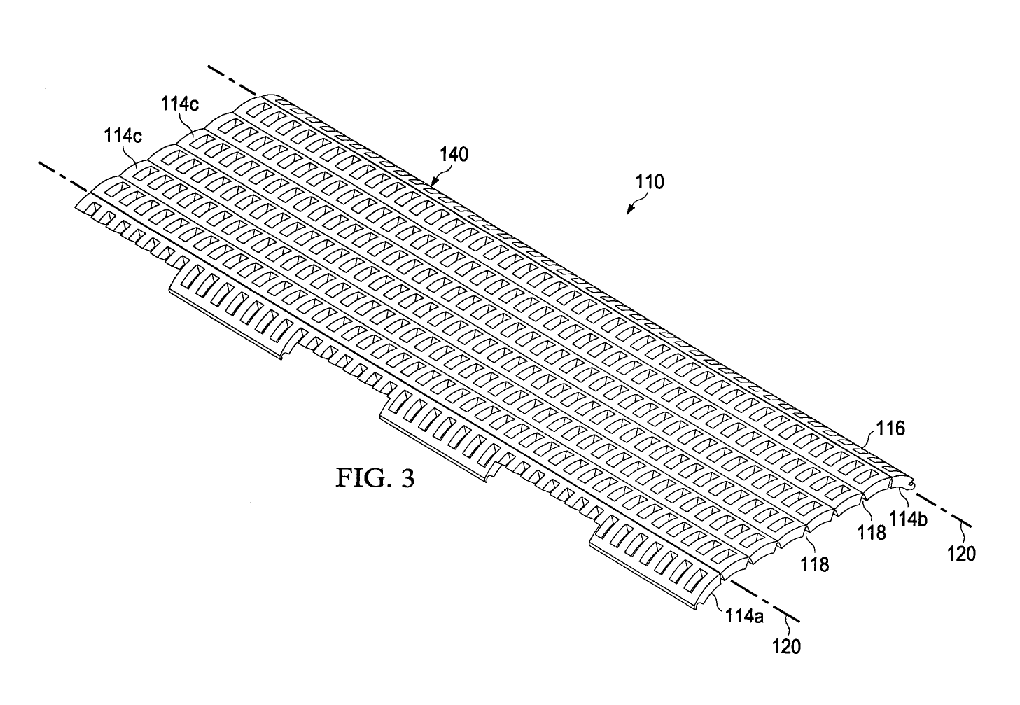

Referring to FIG. 3, the filter support member 110 may be positioned in a stored position to form a substantially flat sheet 140. The flat configuration of the filter support member 110 allows the filter support member 110 to occupy a volumetric envelope that is substantially less than the volumetric envelope occupied by the filter support member 110 positioned in the operational position.

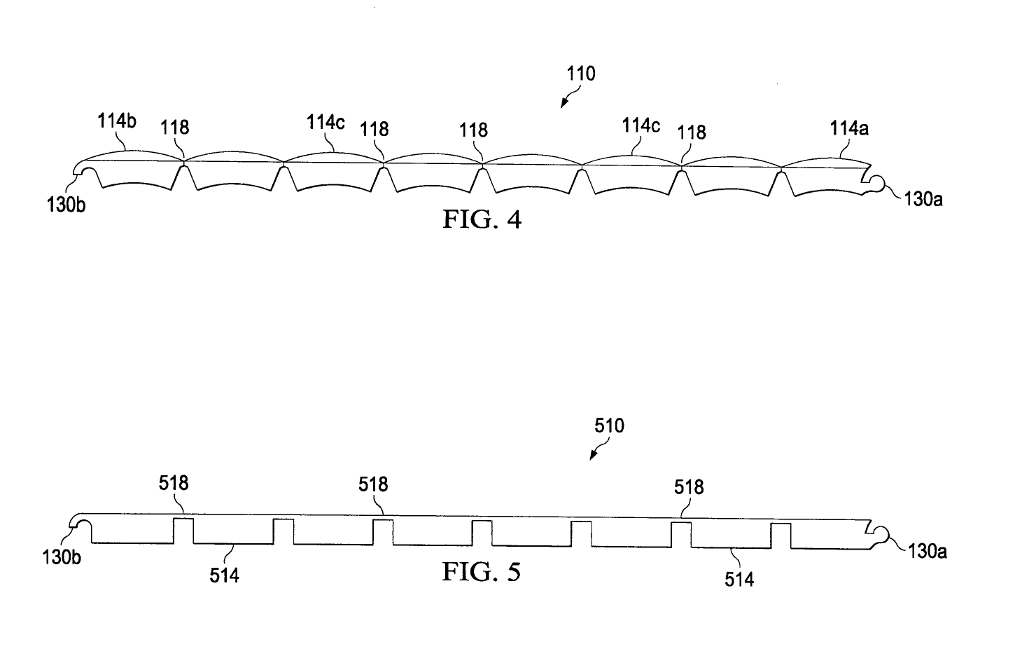

Referring still to FIGS. 1-4, the core members 114 are substantially planar such that when the filter support member 110 is placed in the stored position, the flat sheet 140 is substantially planar. The cross-sectional shape of each core member 114, shown in more detail in FIG. 4, is arcuate. The arcuate shape of each core member 114 allows the filter body 122 in the operational position to more closely approximate the shape of a true cylinder.

The filter support member 110 and the other filter support members described herein may be placed in the stored position or operational position multiple times, thereby allowing reuse of the filter support member following initial use. More specifically, following use of the filter support member in the operational position, the filter support member may be placed in the stored position for storage prior to subsequent uses in the operational position. Such a reuse of the filter support member may be desired if the filter support member is removed from a filtering system to clean or replace filter media associated with the filter support member.

Referring to FIG. 5, a filter support member 510 according to an illustrative embodiment includes a plurality of core members 514 pivotally attached to adjacent core members by hinges 518 or other pivotal-attachment means. The core members 514 are similar in many aspects to the core members 114 of FIGS. 1-4. Unlike core members 114, however, core members 514 are not arcuate in cross-sectional shape, but rather rectangular. The rectangular shape of core members 514 is capable of providing a slightly more planar sheet in the stored position than that provided by the arcuately-shaped core members 114 illustrated in FIG. 4. Additionally, the substantially cylindrical shape of the filter body formed in the operational position may still be maintained as long as multiple core members 514 are provided.

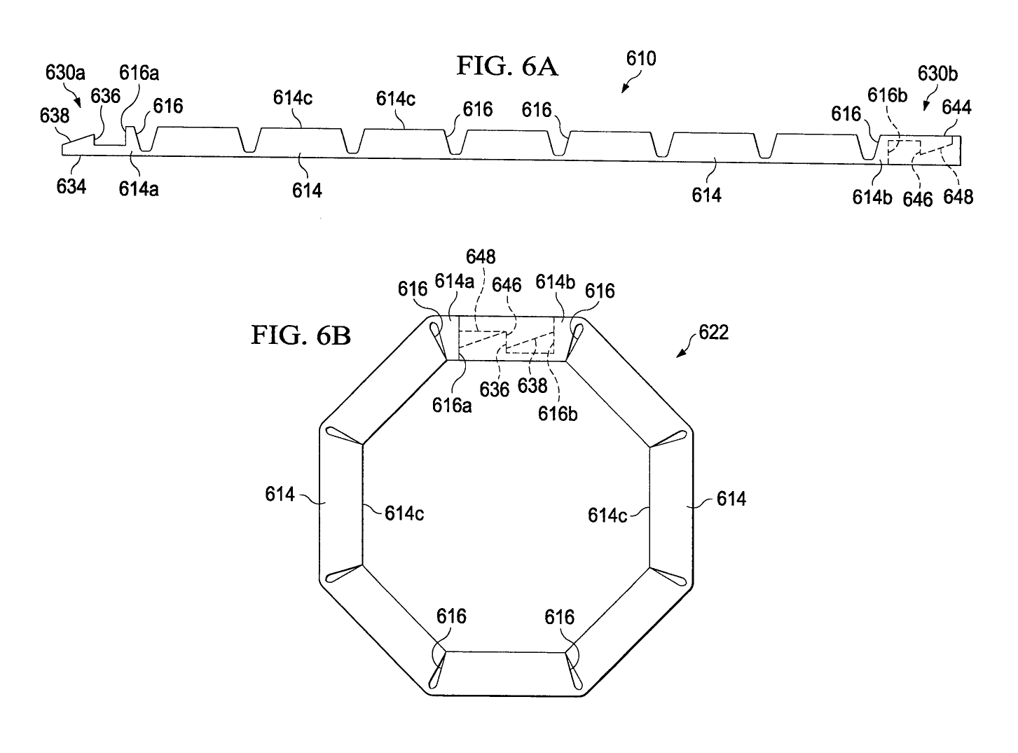

Referring to FIGS. 6A and 6B, a filter support member 610 according to an illustrative embodiment includes a plurality of core members 614 pivotally attached to adjacent core members by hinges 618 or other pivotal-attachment means. The core members 614 are similar in many aspects to the core members 114 and 514 of FIGS. 1-5. Similar to the filter supports members described herein, the filter support member 610 may be placed in a stored position (FIG. 6A) or an operational position (FIG. 6B) to form a filter body 622.

The filter support member 610 may include complimentary latching members 630a, 630b associated with terminal core members 614a, 614b, respectively. The latching members 630a, 630b are each attached along a terminal edge 616a, 616b of the terminal core members 614a, 614b opposite an edge 616 that is pivotally connected to an adjacent intermediate core member 614c. Latching member 630a is a male clasp 634 integrally attached to the edge 616a of terminal core member 614a. The male clasp 634 includes a shoulder 636 and an inclined clasp surface 638. The male clasp 634 may be continuously disposed along the edge 616a, or alternatively, multiple male clasps 634 may be disposed as various positions along the edge 616a. Latching member 630b is a catch 644 that is sized and shaped to matingly receive the male clasp 634. The catch 644 includes a shoulder 646 and an inclined catch surface 648. Like the male clasp 634, the catch 644 may be continuously disposed along the edge 616b, or may be disposed at various positions along the edge 616b, preferably in-line with complimentary male clasps 634 on edge 616a. When the filter support member 610 is placed in the operational position, the latching members 630a, 630b mate such that the shoulder 636 of male clasp 634 and the shoulder 646 of catch 644 are engaged. The inclined surfaces 638, 648 of the male clasp 634 and catch 644 permit easier engagement of the clasp 634 and catch 644.

The engagement of the male clasp 634 and the catch 644 secures the filter support member 610 in the operational position and resists unlatching in the presence of forces applied tangentially to the filter body 622. Additionally, the engagement resists unlatching when exposed to radial forces directed inward or outward on the filter body 622.

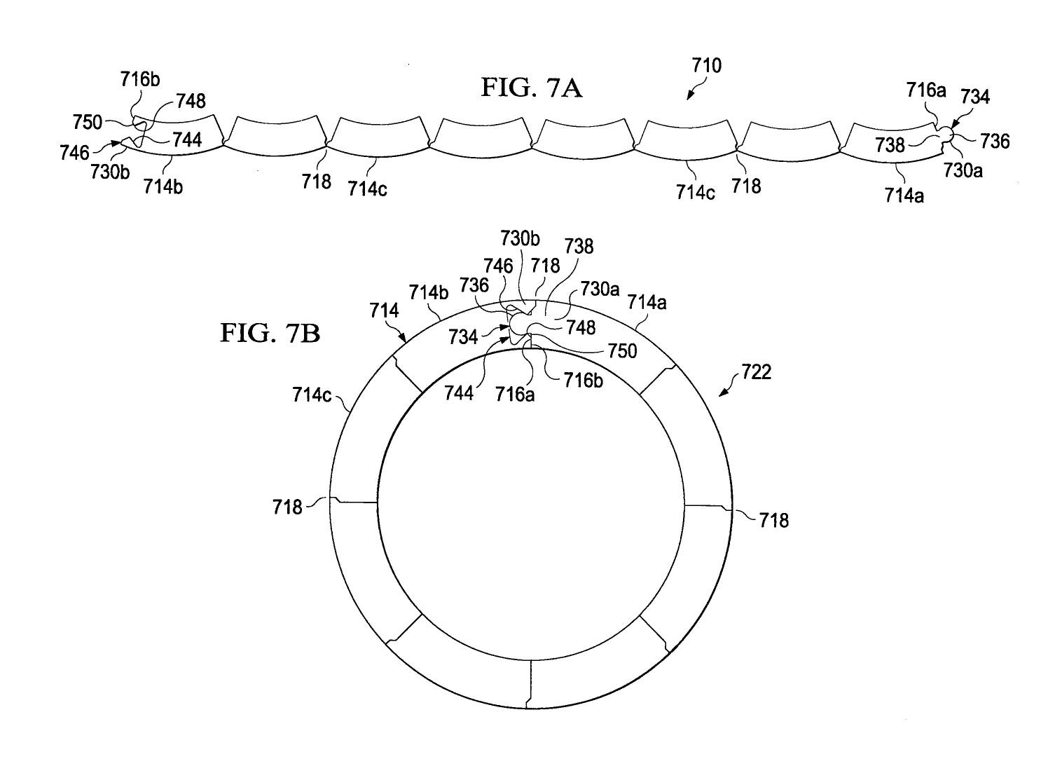

Referring to FIGS. 7A and 7B, a filter support member 710 according to an illustrative embodiment includes a plurality of core members 714 pivotally attached to adjacent core members by hinges 718 or other pivotal-attachment means. The core members 714 are similar in many aspects to the core members 114, 514, and 614 of FIGS. 1-6. Similar to the filter supports members described herein, the filter support member 710 may be placed in a stored position (FIG. 7A) or an operational position (FIG. 7B) to form a filter body 722.

The filter support member 710 may include complimentary latching members 730a, 730b associated with terminal core members 714a, 714b, respectively. The latching members 730a, 730b are each attached along a terminal edge 716a, 716b of the terminal core members 714a, 714b opposite an edge 716 that is pivotally connected to an adjacent intermediate core member 714c. Latching member 730a is a snap post 734 integrally attached to the edge 716a of terminal core member 714a. The snap post 734 includes a spherically-shaped ball 736 and an extension member 738. The snap post 734 may be continuously disposed along the edge 716a, or alternatively, multiple snap posts 734 may be disposed as various positions along the edge 716a. Latching member 730b is a conically-shaped receiver 744 that is sized and shaped to matingly receive the snap post 734. The receiver 744 includes a frusto-conical or tapered surface 746 converging to a neck region 748. Like the snap post 734, the receiver 744 may be continuously disposed along the edge 716b, or may be disposed at various positions along the edge 716b, preferably in-line with complimentary snap posts 734 on edge 716a. When the filter support member 710 is placed in the operational position, the ball 736 of the snap post 734 is pushed through the neck region 748 of the receiver 744. The larger size of the ball 736 compared to the neck region 748 permits an interference and locking fit between the latching members 730a, 730b. An inclined surface 750 on the receiver 744 further permits easier engagement of the snap post 734 and the receiver 744.

The engagement of the snap post 734 and the receiver 744 secures the filter support member 710 in the operational position and resists unlatching in the presence of forces applied tangentially to the filter body 722. Additionally, the engagement resists unlatching when exposed to radial forces directed inward or outward on the filter body 722.

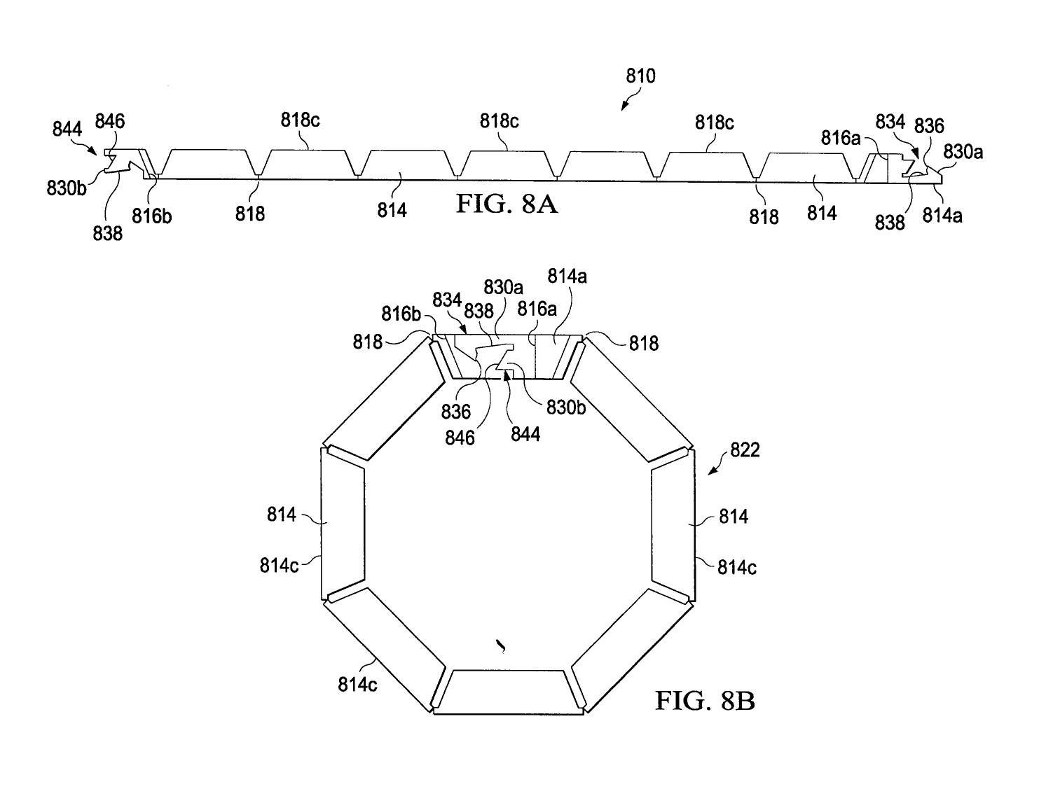

Referring to FIGS. 8A and 8B, a filter support member 810 according to an illustrative embodiment includes a plurality of core members 814 pivotally attached to adjacent core members by hinges 818 or other pivotal-attachment means. The core members 814 are similar in many aspects to the core members 114, 514, 614, and 714 of FIGS. 1-7. Similar to the filter supports members described herein, the filter support member 810 may be placed in a stored position (FIG. 8A) or an operational position (FIG. 8B) to form a filter body 822.

The filter support member 810 may include complimentary latching members 830a, 830b associated with terminal core members 814a, 814b, respectively. The latching members 830a, 830b are each attached along a terminal edge 816a, 816b of the terminal core members 814a, 814b opposite an edge 816 that is pivotally connected to an adjacent intermediate core member 814c. Latching member 830a is a male clasp 834 integrally attached to the edge 816a of terminal core member 814a. The male clasp 834 includes a shoulder 836 and an inclined clasp surface 838. The male clasp 834 may be continuously disposed along the edge 816a, or alternatively, multiple male clasps 834 may be disposed as various positions along the edge 816a. Latching member 830b is a catch 844 that is sized and shaped to matingly receive the male clasp 834. The catch 844 includes a shoulder 846. Like the male clasp 834, the catch 844 may be continuously disposed along the edge 816b, or may be disposed at various positions along the edge 816b, preferably in-line with complimentary male clasps 834 on edge 816a. When the filter support member 810 is placed in the operational position, the latching members 830a, 830b mate such that the shoulder 836 of male clasp 834 and the shoulder 846 of catch 844 are engaged. The inclined surface 838 of the male clasp 834 permits easier engagement of the clasp 834 and catch 844.

The engagement of the male clasp 834 and the catch 844 secures the filter support member 810 in the operational position and resists unlatching in the presence of forces applied tangentially to the filter body 822. Additionally, the engagement resists unlatching when exposed to radial forces directed inward or outward on the filter body 822.

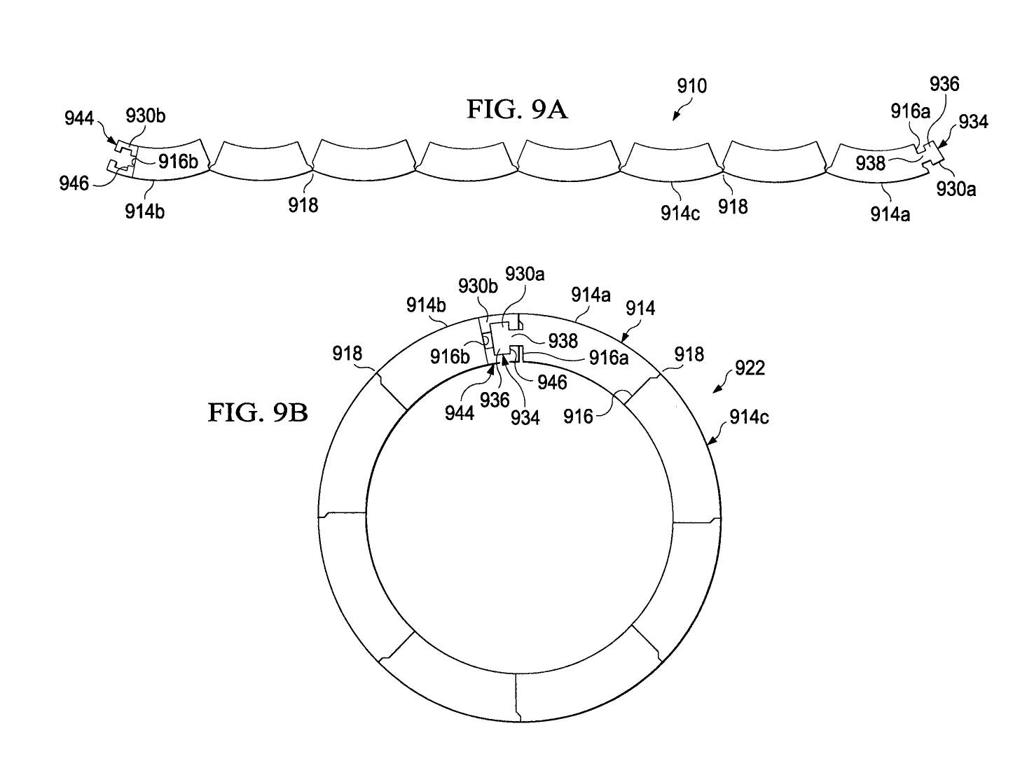

Referring to FIGS. 9A and 9B, a filter support member 910 according to an illustrative embodiment includes a plurality of core members 914 pivotally attached to adjacent core members by hinges 918 or other pivotal-attachment means. The core members 914 are similar in many aspects to the core members 114, 514, 614, 714, and 814 of FIGS. 1-8. Similar to the filter supports members described herein, the filter support member 910 may be placed in a stored position (FIG. 9A) or an operational position (FIG. 9B) to form a filter body 922.

The filter support member 910 may include complimentary latching members 930a, 930b associated with terminal core members 914a, 914b, respectively. The latching members 930a, 930b are each attached along a terminal edge 916a, 916b of the terminal core members 914a, 914b opposite an edge 916 that is pivotally connected to an adjacent intermediate core member 914c. Latching member 930a is a T-shaped clasp 934 integrally attached to the edge 916a of terminal core member 914a. The T-shaped clasp 934 includes a head 936 and an extension member 938. The T-shaped clasp 934 may be continuously disposed along the edge 916a, or alternatively, multiple T-shaped clasps 934 may be disposed as various positions along the edge 916a. Latching member 930b is a catch 944 that is sized and shaped to matingly receive the T-shaped clasp 934. The catch 944 includes a shoulder 946. Like the T-shaped clasp 934, the catch 944 may be continuously disposed along the edge 916b, or may be disposed at various positions along the edge 916b, preferably in-line with complimentary male clasps 934 on edge 916a. When the filter support member 910 is placed in the operational position, the latching members 930a, 930b mate such that the head 936 of T-shaped clasp 934 and the shoulder 946 of catch 944 are engaged.

The engagement of the T-shaped clasp 934 and the catch 944 secures the filter support member 910 in the operational position and resists unlatching in the presence of forces applied tangentially to the filter body 922. Additionally, the engagement resists unlatching when exposed to radial forces directed inward or outward on the filter body 922.

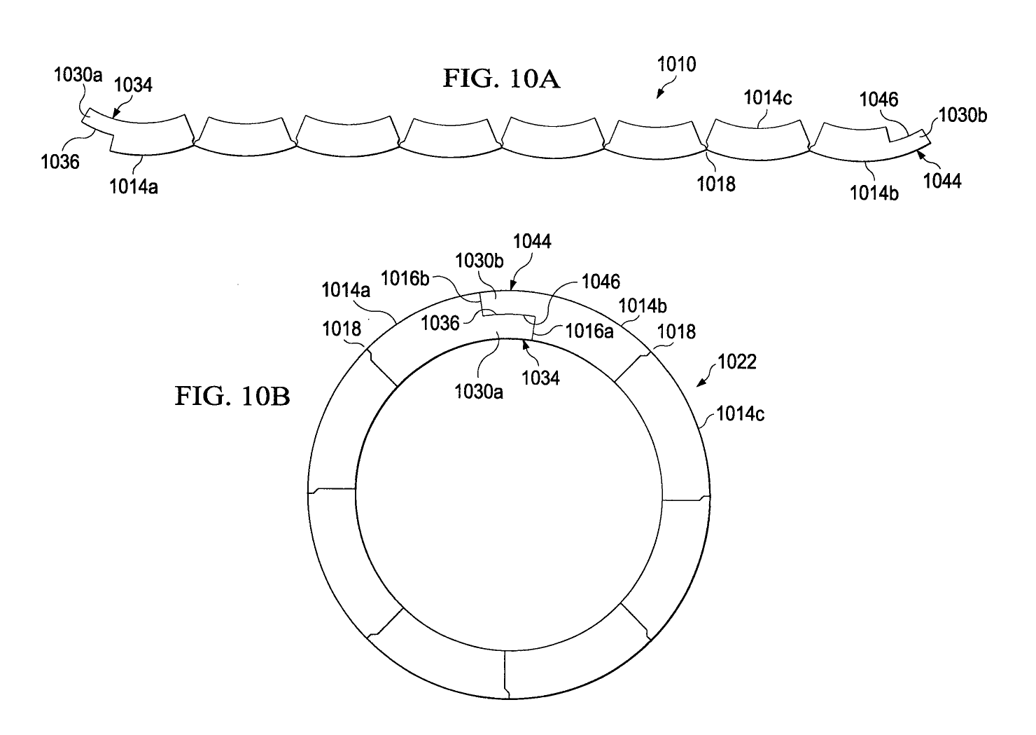

Referring to FIGS. 10A and 10B, a filter support member 1010 according to an illustrative embodiment includes a plurality of core members 1014 pivotally attached to adjacent core members by hinges 1018 or other pivotal-attachment means. The core members 1014 are similar in many aspects to the core members 114, 514, 614, 714, 814, and 914 of FIGS. 1-9. Similar to the filter supports members described herein, the filter support member 1010 may be placed in a stored position (FIG. 10A) or an operational position (FIG. 10B) to form a filter body 1022.

The filter support member 1010 may include complimentary latching members 1030a, 1030b associated with terminal core members 1014a, 1014b, respectively. The latching members 1030a, 1030b are each attached to the terminal core members 1014a, 1014b, respectively, opposite an edge 1016 that is pivotally connected to an adjacent intermediate core member 1014c. Latching member 1030a is an L-shaped extension 1034 integrally attached to the edge 1016a of terminal core member 1014a. The L-shaped extension 1034 includes a mating surface 1036. The L-shaped extension 1034 may be continuously disposed along the edge 1016a, or alternatively, multiple L-shaped extensions 1034 may be disposed as various positions along the edge 1016a. Latching member 1030b is an L-shaped extension 1044 that is sized and shaped to be complimentary to and matingly receive the L-shaped extension 1034. The L-shaped extension 1044 includes a mating surface 1046. Like the L-shaped extension 1034, the L-shaped extension 1044 may be continuously disposed along the edge 1016b, or may be disposed at various positions along the edge 1016b, preferably in-line with complimentary L-shaped extension 1034 on edge 1016a. When the filter support member 1010 is placed in the operational position, the latching members 1030a, 1030b mate such that the mating surface 1036 of L-shaped extension 1034 and the mating surface 1046 of L-shaped extension 1044 are engaged.

The engagement of the L-shaped extension 1034 and the L-shaped extension 1044 does not resist unlatching in the presence of forces applied tangentially to the filter body 1022. However, the engagement resists unlatching when exposed to radial forces directed inward or outward on the filter body 1022.

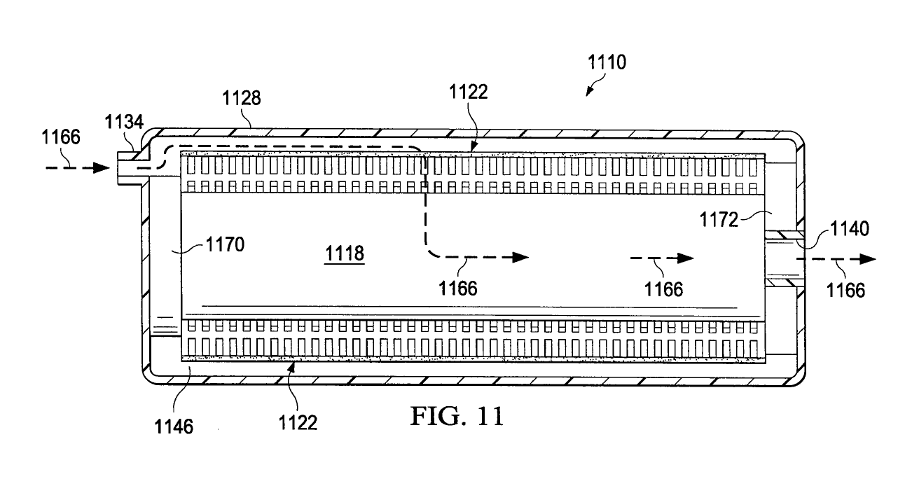

Referring to FIG. 11, a filter 1110 according to an illustrative embodiment includes a filter support member 1118 and a filter media 1122, both positioned within a filter housing 1128. The filter housing includes an inlet port 1134 and an outlet port 1140, both in fluid communication with an inner chamber 1146 within which are positioned the filter support member 1118 and the filter media 1122.

In the embodiment illustrated in FIG. 11, the filter support member 1118 is similar in construction to those filter support members described and illustrated herein. In FIG. 11, the filter support member 1118 is shown in the operational position with an inner passage similar to those previously described. The filter support member 1118 is surrounded by the filter media 1122, which could be any suitable filtering material. Each end of the filter support member 1118 is secured by an end cap 1170, 1172. The end caps 1170, 1172 may assist in securing the filter support member 1118 in the operational position either in addition to or in lieu of the latching mechanisms described herein. The end cap 1170 at a first end of the filter support member 1118 also provides a sealing function to prevent liquid from entering the inner passage of the filter support member through the first end. At a second end of the filter support member 1118, the end cap 1172 is positioned between the filter housing 1128 and the filter support member 1118. The end cap 1172 includes a passage that is aligned with the outlet port 1140 to allow fluid communication from the inner passage of the filter support member 1118 through the passage of the end cap 1172 and the outlet port 1140. The presence of the end cap 1172 maintains a seal between the end cap 1172 and the filter housing 1128 to ensure that fluid entering the inner chamber 1146 passes through the filter media 1122 and into the inner passage of the filter support member 1118 prior to exiting the outlet port 1140 of the filter housing 1128. Fluid flow into, through, and out of the filter is illustrated by arrows 1166.

While the filter 1110 in FIG. 10 is configured to permit a particular path of fluid flow, it should be noted that multiple filter and fluid flow configurations are possible using the filter support members described herein. In one embodiment, unfiltered fluid (i.e. gas or liquid) may be allowed to enter the inner passage of the filter support member through an end cap positioned on the filter support member and then exit the filter housing after passing through the filter media 1122. It should also be noted that the filter media 1122 may in some embodiments be positioned within the inner passage of the filter support member 1118.

Filters such as filter 1110, as well as the filter support members described herein, are frequently used in the oil and gas industry to filter or clean production liquids and gases. Alternatively, the filters may be used to clean other liquids or gases in the oil and gas industry or other industries. The filter support elements are capable of being positioned, and even manufactured, in a stored position that is essentially flat or planar. By eliminating the inner passage or hollow space that is a part of the filter support member in its operational position, the filter support member in the stored position occupies much less volume, making shipping and storage less expensive. Additionally, the ability to manufacture the filter support member without the hollow space allows more flexible and less expensive manufacturing techniques to be used. While traditional filter support members having a fixed hollow space would require manufacturing by more complication injection-molding techniques, the filter support members described herein may be manufactured using traditional injection molding or other molding techniques.

The material from which the filter support members may be made varies widely, and the list of available materials is broadened due to the increased flexibility in manufacturing. Example of materials that may be used include without limitation polyethylene, polypropylene, polyvinyl chloride (PVC), nylon, polycarbonate, acrylonitrile butadiene styrene (ABS), acetal, acrylic, epoxy, fluorocarbons, ionomer, polybutylene, polyester, polystyrene, polyurethane, and silicone, or any other suitable materials.

The filter support members described herein are provided in some embodiments with latching components or mechanisms that allow the filter support member to remain in or be secured in the operational position. However, integral latching components such as those illustrated in some of the figures are not necessarily required in every embodiment. In some embodiments, including those described herein, the filter support element instead may be held in the operational position by tape, end caps, rings, staples, clips, adhesives, wires, bands (elastomeric, polymeric, or metallic), split rings, screws, rivets, heat stakes, thermal bonding, sonic welding or other welding, pinning, or any other attachment means. In still other embodiments, the filter support member may not include an integrated latching component, but instead may be held in the operational position by the placement of the filter media around, inside of, or in contact with the filter support member.

It should be apparent from the foregoing that an invention having significant advantages has been provided. While the invention is shown in only a few of its forms, it is not just limited but is susceptible to various changes and modifications without departing from the spirit thereof.

I claim:

1. An apparatus for supporting filter media, the apparatus comprising:
a plurality of core members;
a hinge positioned between at least two of the plurality of core members to allow pivotal movement of the at least two core members relative to one another about a hinge axis associated with the hinge;
wherein the plurality of core members are positionable in an operational position to form a substantially cylindrical body;
wherein the plurality of core member are positionable in a stored position to form a substantially flat sheet, the substantially flat sheet occupying a volumetric envelope less than a volumetric envelope of the substantially cylindrical body.

2. The apparatus of claim 1, wherein:
each of the plurality of core members pivotally attached to at least another of the plurality of core members; and
the hinge axis of the hinge is substantially parallel to a second hinge axis associated with a second hinge positioned between another pair of core members.

3. The apparatus of claim 1, wherein the substantially cylindrical body includes a longitudinal axis substantially parallel to the first hinge axis.

4. The apparatus of claim 1, wherein the hinge is a living hinge.

5. The apparatus of claim 4, wherein the living hinge is made from the same material as the plurality of core members.

6. The apparatus of claim 1, wherein each of the plurality of core members is substantially planar.

7. The apparatus of claim 1, wherein each of the plurality of core members is arcuately shaped.

8. The apparatus of claim 1, wherein:
the substantially cylindrical body includes an inner passage; and
each of the plurality of core members includes a plurality of apertures, the apertures allowing fluid communication between the inner passage and a space adjacent an exterior surface of the substantially cylindrical body.

9. A filter comprising:
a filter support member having a substantially cylindrical body comprised of a plurality of core members, each of the plurality of core members pivotally attached to at least another of the plurality of core members; and
a filter media positioned adjacent to or in contact with the substantially cylindrical body.

10. The filter of claim 9, wherein the filter support member is positionable in an operational position in which the plurality of core members are arranged to form the substantially cylindrical body.

11. The filter of claim 10, wherein the plurality of filter support member is positionable in a stored position in which all of the plurality of core members are arranged to form a substantially flat sheet.

12. The filter of claim 11, wherein the substantially flat sheet occupies a volumetric envelope less than a volumetric envelope of the substantially cylindrical body.

13. The filter of claim 9, wherein the pivotal connection between a pair of adjacent core members is provided by one or more hinges having a hinge axis about which the pair of adjacent core embers are capable of rotating.

14. The filter of claim 13, wherein the hinge axis associated with the one or more hinges is substantially parallel to a second hinge axis associated with one or more hinges positioned between another pair of adjacent core members.

15. The filter of claim 14, wherein the substantially cylindrical body includes a longitudinal axis substantially parallel to the first hinge axis.

16. The filter of claim 14, wherein each hinge is a living hinge.

17. The filter of claim 16, wherein the living hinge is made from the same material as the plurality of core members.

18. The filter of claim 9, wherein each of the plurality of core members is substantially planar.

19. The filter of claim 9, wherein each of the plurality of core members is arcuately shaped.

20. The filter of claim 9, wherein:
the substantially cylindrical body includes an inner passage; and
each of the plurality of core members includes a plurality of apertures, the apertures allowing fluid communication between the inner passage and a space adjacent an exterior surface of the substantially cylindrical body.

21. An apparatus for supporting filter media, the apparatus comprising:
a plurality of core members, each of the plurality of core members pivotally attached to at least another of the plurality of core members;
wherein the plurality of core members are positionable in an operational position to form a filter support body;
wherein the plurality of core member are positionable in a stored position to form a sheet, the sheet occupying a volumetric envelope less than a volumetric envelope of the substantially cylindrical body.

22. The apparatus of claim 21, wherein the pivotal connection between a pair of adjacent core members is provided by one or more hinges having a hinge axis about which the pair of adjacent core embers are capable of rotating.

23. The apparatus of claim 22, wherein the hinge axis associated with the one or more hinges is substantially parallel to a second hinge axis associated with one or more hinges positioned between another pair of adjacent core members.

24. The apparatus of claim 23, wherein the filter support body includes a longitudinal axis substantially parallel to the first hinge axis.

25. The apparatus of claim 23, wherein each hinge is a living hinge.

26. The apparatus of claim 25, wherein the living hinge is made from the same material as the plurality of core members.

27. The apparatus of claim 21, wherein each of the plurality of core members is substantially planar.

28. The apparatus of claim 21, wherein each of the plurality of core members is arcuately shaped.

29. The apparatus of claim 21, wherein:
the filter support body includes an inner passage; and
each of the plurality of core members includes a plurality of apertures, the apertures allowing fluid communication between the inner passage and a space adjacent an exterior surface of the substantially cylindrical body.

30. The apparatus of claim 21, wherein the filter support body is cylindrical.

31. The apparatus of claim 21, wherein the filter support body includes a square cross-sectional shape.

32. The apparatus of claim 21, wherein the filter support body includes a triangular cross-sectional shape.
